(19) United States
(12) Patent Application Publication
(10) Pub. No.: US 2012/0086622 A1
(43) Pub. Date: Apr. 12, 2012

(54) Construction Set Package for Constructing a Cellular Antenna Site

(76) Inventor: Jan Angseryd, Taby (SE)

(21) Appl. No.: 13/110,416

(22) Filed: May 18, 2011

Related U.S. Application Data
(60) Provisional application No. 61/390,321, filed on Oct. 6, 2010.

(30) Foreign Application Priority Data
May 5, 2011 (SE) PCT/SE2011/050564

(51) Int. Cl. H01Q 1/08; H01Q 1/12

(52) U.S. Cl. 343/880

(57) ABSTRACT

The present application relates to a portable construction set package for constructing a cellular antenna site. The portable construction set package comprises a package box and at least one antenna. The package box is adapted to protect the at least one antenna prior to construction of the cellular antenna site. The package box comprises a plurality of package box parts. At least one of the plurality of package box parts is adapted to form a part of the cellular antenna site.

### RELATED APPLICATIONS

This application claims priority to U.S. Provisional Patent Application No. 61/390,321, filed Oct. 6, 2010, and to International Patent Application No. PCT/SE2011/050564, filed May 5, 2011, each of which is incorporated herein by reference in its entirety.

### TECHNICAL FIELD

The present application relates generally to cellular antenna sites in a wireless communication network and more particularly to a portable construction set package for constructing a cellular antenna site.

### BACKGROUND

The continued proliferation and widespread use of wireless telecommunications equipment has brought with it the need for more self-contained cellular antenna sites. Typical methods of deploying cellular antennas are on permanent structures such as towers or monopoles, or on rooftops. When based on the ground, the permanent structures are normally supported on conventional foundations such as reinforced concrete slabs or pads, and often the concentrated weight of a tall antenna tower has required a relatively substantial and separate foundation member such as a deep reinforced concrete pier. Therefore, these structures often require special zoning and permitting, soil core sampling, engineering, excavation, and the use of heavy equipment and cranes to perform installation, all of which may be costly and time consuming. In addition, the time required to pour and cure a concrete foundation may delay the erection of an antenna and ultimately the operation of the cellular antenna site. Further, such a permanent cellular antenna site is not readily removed and redeployed at another location, and even if relocated, the permanent foundation remains.

Document GB2436573 A discloses a tower for mounting communications equipment, the tower comprising a base and a column, wherein at least a portion of the base is adapted to receive ballast. Since the tower is stabilized with ballast, no permanent foundation is required and the tower can be easily placed at any location with little site preparation. Without the ballast, the tower can be moved easily.

Document US2004/0233120 A1 discloses a portable modular cellular antenna site capable of being deployed on any substantially flat piece of ground, the cellular antenna site being easily assembled, disassembled and moved without the aid of heavy equipment. The cellular antenna site includes a modular base configurable in different geometric arrangements from similar base modules. The base retains ballast material, e.g. concrete blocks, gravel or poured concrete and supports an antenna.

In order to ensure functionality when a cellular antenna site has been mounted, the parts of the cellular antenna site have to be protected during transportation and storage. Therefore, protecting packages are provided that protect the cellular antenna site parts during the whole transport chain. For example, steel containers may be used for protecting and packaging cellular antenna site parts during transport to their place of installation.

Today, parts for cellular antenna sites comprise at least the antenna itself, an antenna support unit and a tilt unit. Each of these at least three parts is packaged in a separate protecting package, for example a box or a container. After installation, the protecting packages have to be removed from the antenna site. Protecting packages may either be re-used, recycled or discarded. The protecting packages have to be transported from the site to a location for recycling or re-use of the protecting packages or a disposal plant.

### SUMMARY

It is an object to provide a construction set package for a cellular antenna site that has improved environmental properties. It is another object to reduce the costs related to the construction of a cellular antenna site.

At least one of these objects is achieved by a portable construction set package for constructing a cellular antenna site. The portable construction set package comprises a package box and at least one antenna. The package box is adapted to protect the at least one antenna prior to construction of the cellular antenna site. The package box comprises a plurality of package box parts. At least one of the plurality of package box parts is adapted to form a part of the cellular antenna site.

Since at least one of the plurality of package box parts forms a part of the cellular antenna site, costs and efforts for removing package box parts from the antenna site location after construction of the cellular antenna site are reduced. Furthermore, costs for recycling of package box parts and transports costs for transporting the package box parts to a location for re-use or recycling or to a disposal plant may be reduced.

Other objects, advantages and novel features will become apparent from the following detailed description.

### BRIEF DESCRIPTION OF THE DRAWINGS

The arrangements are in more detail described with reference to the attached drawings, in which:

FIG. 1 illustrates a first embodiment of a portable construction set package for constructing a cellular antenna site prior to construction,

FIG. 2 illustrates a cellular antenna site erected from a portable construction set package according to FIG. 1,

FIG. 3 illustrates a second embodiment of cellular antenna site erected from a portable construction set package according to FIG. 1.

FIG. 4 illustrates a third embodiment of a cellular antenna site erected from a portable construction set package according to FIG. 1.

FIG. 5 illustrates a fourth embodiment of an antenna site erected from a portable construction according to FIG. 1.

FIG. 6 illustrates a second embodiment of a portable construction set package for constructing a cellular antenna site prior to construction in a view from above,

FIG. 7 illustrates the portable construction set package of FIG. 6 in a view from below,

FIG. 8 shows the portable construction set package with one sidewall of the package box removed,

FIG. 9 shows a cellular antenna site constructed from the portable construction set package illustrated in FIGS. 6, 7 and 8 in a view from below and

FIG. 10 illustrates the cellular antenna site of FIG. 9 in the assembled state in a front view.

### DETAILED DESCRIPTION

Further objects and features may become apparent from the following detailed description considered in conjunction with the accompanying drawings. It is to be understood, however, that the drawings are designed solely for purposes of illustration and not as a definition of the limits of the herein disclosed embodiments, for which reference is to be made to the appended claims. It is further to be understood that the drawings are not necessarily drawn to scale and that, unless otherwise indicated, they are merely intended to conceptually illustrate the structures and procedures described herein.

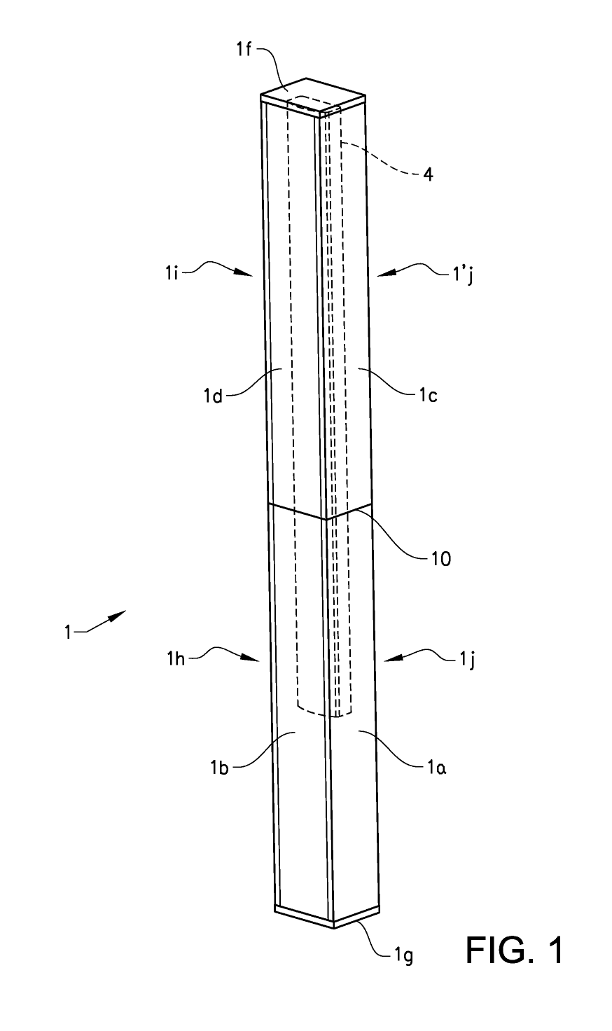

FIG. 1 illustrates a portable construction set package for constructing a cellular antenna site prior to construction, e.g. during transport to the site or during storage of one or a plurality of construction set packages according to a first embodiment. The portable construction set package is fabricated as a set of components, some of which are pre-assembled into sub-structures in order to facilitate onsite deployment. The portable construction set package is easily transported to a required location and can be assembled without the need for heavy equipment.

The constructions set package comprises a package box 1 comprising a plurality of package box parts. According to a preferred embodiment, the package box 1 is mainly made of wood. Wood is a material with strong construction properties, but is as a renewable raw material particular environmentally friendly. The production of a package box from wood requires normally less recourses, e.g. in terms of energy and carbon dioxide emission, as from other comparable materials such as steel or plastics. Furthermore, wood has slightly shock-absorbing properties, which makes this material in particular suitable as package box material. Although a package box mainly made of wood is preferred, it is possible to combine wood with other material, e.g. plastics, steel, aluminum or any other metal or to make the whole package box essentially either from metal or from plastics or any other suitable material or a combination of these materials. It is also possible to produce the package box essentially from wood and to reinforce parts exposed to particular tension by metal or steel parts. Aluminum is a strong, light-weight material with very good corrosion properties, making aluminum a good choice for constructions exposed to outdoor environment.

According to an example embodiment, the package box 1 has a rectangular cross-section. Boxes with cross-sectional shape are very easy to handle, e.g. to pile up during transport and storage without requiring unnecessary volume. However, other shapes or cross-sections, e.g. circular or five-edged, are also possible.

The package box 1 has a rectangular cross-section and comprises a plurality of package box parts 1a-1k, namely a bottom plate 1g, a top plate 1f and four sidewalls. Each of the sidewalls comprises an upper part 1i, 1j′, 1d, 1c adjacent to the top plate 1f and a lower part 1a, ab, 1h, 1j adjacent to the bottom plate 1g. Three of the upper sidewall parts 1i, 1d, 1c may be alongside connected to each other to form an upper U-shaped member and three of the lower sidewall parts 1a, 1b, 1h, 1j may in similarity be connected alongside to form a lower U-shaped member. The upper U-shaped member formed by the upper sidewall parts 1i, 1j′, 1d, 1c and the lower U-shaped member formed by the lower sidewall parts 1a, 1b, 1h, 1j may be sealingly connected to each other by a joint part 10. The joint part 10 may be removable such that at least some of the upper sidewall parts 1i, 1j′, 1d, 1c are disconnected from the lower sidewall parts 1a, 1b, 1h, 1j when the joint part is removed. One or several of the upper sidewall parts 1i, 1j′, 1d, 1c and the lower sidewall parts 1a, 1b, 1h, 1j may be formed in one part, i.e. without any joint part there between. In case that no joint part is provided between the upper sidewall parts 1i, 1j′, 1d, 1c and the lower sidewall parts 1a, 1b, 1h, 1j it is possible to disconnect the upper sidewall parts 1i, 1j′, 1d, 1c from the lower sidewall parts 1a, 1b, 1h, 1j, e.g. by sawing.

The fourth sidewall 1j, 1j′ may be formed in one part and not include a joint. In this embodiment an antenna 4 is fixedly attached to the sidewall 1j, 1j′ and prior to construction of the cellular antenna site located inside the package box.

According to an example embodiment of the present invention, at least one of the plurality of package box parts is adapted to form a part of the cellular antenna site. Preferably, several parts of the plurality of package box parts, for example all parts of the plurality of package box parts form construction parts of the cellular antenna site. By such an arrangement, transportation of package box parts from the cellular antenna site after construction is completely avoided, thus reducing transportation costs and transportation emission. Furthermore, the package box parts are effectively re-used as parts of the cellular antenna site construction parts, thus reducing costs and use of material and providing an environmentally friendly solution.

According to a preferred embodiment, at least one of said package box parts is adapted to form an elongated support member for supporting an antenna of a cellular antenna site. The elongated support member may be formed by a sidewall of the package box. In order to reduce construction workload to be performed on the site, the antenna may be fixedly attached to the sidewall of the package box while the antenna is positioned inside the package box, e.g. during transport and storage of the portable construction set package. Alternatively, the antenna may be preassembled with an elongated member not being a sidewall of the package box and be positioned together with the elongate member inside the package box prior to construction of the cellular antenna site, while the elongate member is adapted to form the elongated support member of the cellular antenna site.

Even other equipment for the cellular antenna site may be pre-assembled with a sidewall of the package box or an elongated member and positioned inside the package box prior to construction of the cellular antenna site. Examples of such equipment are a radio remote unit (RRU), lightening equipment or a GPS antenna. However, this equipment may also be provided separately or inside the package box and may be mounted to the elongated support member during construction of the cellular antenna site.

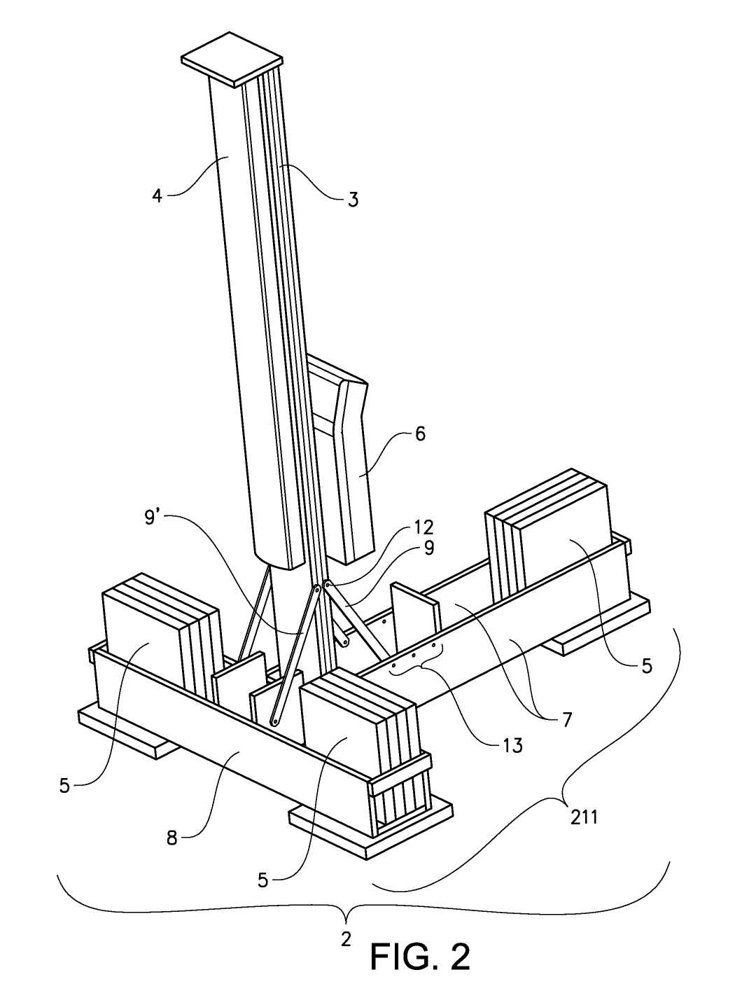

Referring to the example embodiment illustrated in FIG. 1, the fourth sidewall 1j, 1j′ will form an elongate support member 3, 33, 43 of the cellular antenna site 2, 32, 42 as illustrated in FIGS. 2-4. If the antenna is already pre-assembled with a sidewall of the package box when the construction set package is transported to a site, the assembly on site is facilitated. Alternatively, a separate elongated support member (not shown) may be provided inside the package box, and the antenna 4 may be fixedly attached to the separate elongated support member inside the package box.

Since the antenna 4 is positioned inside the package box 1 prior to construction of the cellular antenna site 2, 32, 42, i.e. during transportation and storage of the portable construction set package, the antenna 4 is protected by the package box 1.

FIG. 2 illustrates a first embodiment of a cellular antenna site 2 constructed from a portable construction set package as illustrated in FIG. 1. The side wall 1j, 1j′ of the package box 1 now functions as an elongated support member 3, and the antenna 4 is fixedly attached to the elongated support member 3. A RRU 6 is fixedly attached to the reverse side of the elongated support member 3. Alternatively, a separate part other than one of the sidewalls of the package box 1 may be used as an elongated support member. In this case, the separate elongated support member 3 may be fixedly attached inside the package box 1 prior to construction or it may be provided separately in addition to the package box (not shown).

According to an example embodiment, the cellular antenna site comprises a base member, whereby at least one package box part is adapted to form a part of the base member. The base member is adapted to securely anchor the cellular antenna site to the ground. According to example embodiments, the base member is adapted to retain ballast material. The ballast material might be concrete blocks, stones or other heavy material. The cellular antenna site may be non-penetratingly secured to the ground on which it rests and may be situated on any relatively level and flat piece of ground, including a roof, a parking lot, a gravel lot, a patch of grass or undeveloped land. The base of the cellular antenna site may not require any excavation or permanent foundation, if the cellular antenna site is anchored to the ground by the ballast material. The entire cellular antenna site may, thus, be completely disassembled into its original component parts and removed from the location without leaving a trace of it having been installed.

The construction of the cellular antenna site 2 as illustrated in FIG. 2 from the portable construction set package of FIG. 1 will now be described more detailed. Prior to assembly of the cellular antenna site, a location should be selected that is relatively flat and level. Acceptable site locations include a parking lot, a gravel lot, a flat rooftop capable of supporting the required weight, and a relatively flat and level patch of grass or undeveloped ground.

During construction of the cellular antenna site 2, the joint 10 for connecting the upper u-shaped member and the lower u-shaped member of the package box is removed. Alternatively, the upper u-shaped member 1i, 1d, 1c is disconnected from the lower u-shaped member 1h, 1b, 1a, e.g. by sawing or cut-off grinding. The upper u-shaped member 1i, 1d, 1c is adapted to form a first part 7 of a base member 211 and the lower u-shaped member 1h, 1b, 1a is adapted to form a second part 8 of the base member 211 of the cellular antenna site 2. Other configurations are also possible, e.g. that the first base member part 7 is formed by the lower u-shaped member 1h, 1b, 1a and the second base member part 8 is formed by the upper u-shaped member 1i, 1d, 1c. The first and the second base member part (7, 8) have a box-like shape with an open upper side.

The first part 7 and the second part 8 of the base member 11 are fixedly attached to each other by fastening means, e.g. screws or nails and form together the base member 211. The base member 211 is adapted to retain ballast material 5.

If a temporary and non-damaging installation is to be achieved, concrete blocks or stones 5 may be used as ballast material within the base member 11 for anchoring the base member 211 to the ground. A slightly more permanent installation may be achieved by using poured concrete as ballast material, either alone or in combination with another suitable material, e.g. stones. When poured concrete is used as ballast material the base member 211 needs to have a shape that prevents the poured concrete from running out of the base member 211.

As described in more detail below, the elongated support member 3 is fixedly attached to the base member 211 by fastening means 12, 9. Either the elongated support member 3 may be mounted to the base member 211 before the base member 211 is filled with ballast material 5 or after the base member has been filled with ballast material 5. Although the second possibility is preferred, for smaller antennas it might be convenient to choose the first alternative.

The positions of antennas of wireless communication systems often need to be adjusted, normally at least when installed for the first time. According to example embodiments, fastening means for attaching the elongated support member 3 to the base member 211 may comprise tilting means 13 for tilting the elongated support member 3 with respect to the base member 211. The fastening means may comprise a first attachment point 12 on the elongated support member 3 and an attachment device 9 attachable to the first attachment point and the tilting means 13 may comprise a plurality of base member attachment points provided on the base member 211. The attachment device 9 may be attached to at least one base member attachment point selectable out of the plurality of base member attachment points. By these features, the antenna may be tilted at a desired angle in a very convenient and cost-effective manner.

In order to enable such an adjustment, the fastening means 12, 9 for attaching the elongated support member 3 to the base member 211 comprise tilting means 13 for tilting the elongated support member 3 and, consequently, also the antenna 4 attached to the elongated support member 3. The elongated support member 3 may either be positioned inside the first part 7 of the base member 7 as illustrated in FIG. 2 or inside the second part 8 of the base member (not shown), whereby inner side walls of the first or second part 7, 8 of the base member 3 provide a certain support against a sideward movement of the elongated support member 3. Optionally, the elongated support member 3 may be rotatably connected to the base member 211 by a first and a second screw (not shown) whereby the first and second screw together form an axis of rotation for the elongated support member 3.

In order to securely fasten the elongated support member 3 to the base member 211 a support member attachment point in the form of a hole 12 is provided on the elongated support member 3. An attachment device such as a link 9 is attached to the support member attachment point 12. The base member 211 is provided with a plurality of holes serving as a plurality of base member attachment points 13 whereby the link 9 is attachable to one of the plurality of base member attachment points 13. During construction of the cellular antenna site 2 the elongated support member 3 is positioned in a desired position, i.e. with a desired tilting angle and the attachment device 9 is attached to the support member attachment point 12. Thereafter, a suitable base member attachment point out of the plurality of base member attachment points is chosen and the attachment device is connected to this base member attachment point. Thereby, the elongated support member 3 and consequently also the antenna 4 are connected to the base member 211 and securely positioned with the desired tilting angle. Alternatively, it is possible to provide a plurality of attachment points such as holes in the elongated support member instead or in addition to the plurality of attachment points in the base member 211. As a further alternative, instead or in addition to the plurality of base member attachment points 13 and/or the plurality of elongated support member attachment points 13, the attachment device 9 may be provided with a plurality of holes. One of the plurality of holes in the attachment device 9 is chosen for attachment to the first attachment point 12 on the elongated support member and another of the plurality of holes in the attachment device 9 is chosen for attachment to a base member attachment point 13. Optionally, it is possible to provide a further attachment device, e.g. a further link 9′ connectable to the elongated support member and the base member in a similar way as the attachment device 9. Thereby, stability of the cellular antenna site in general and the connection of the elongated support member 3 to the base member 3 in the chosen position in particular is improved.

The support member attachment points 12 and the base member attachment points 13 may be markings instead of holes in order to indicate the possible positions for the attachment device 9. This is in particular suitable if the package box is essentially made from wood. Due to the special properties of wood well known to one skilled in the art, fastening means such as screws or nails can be directly mounted without the provision of holes.

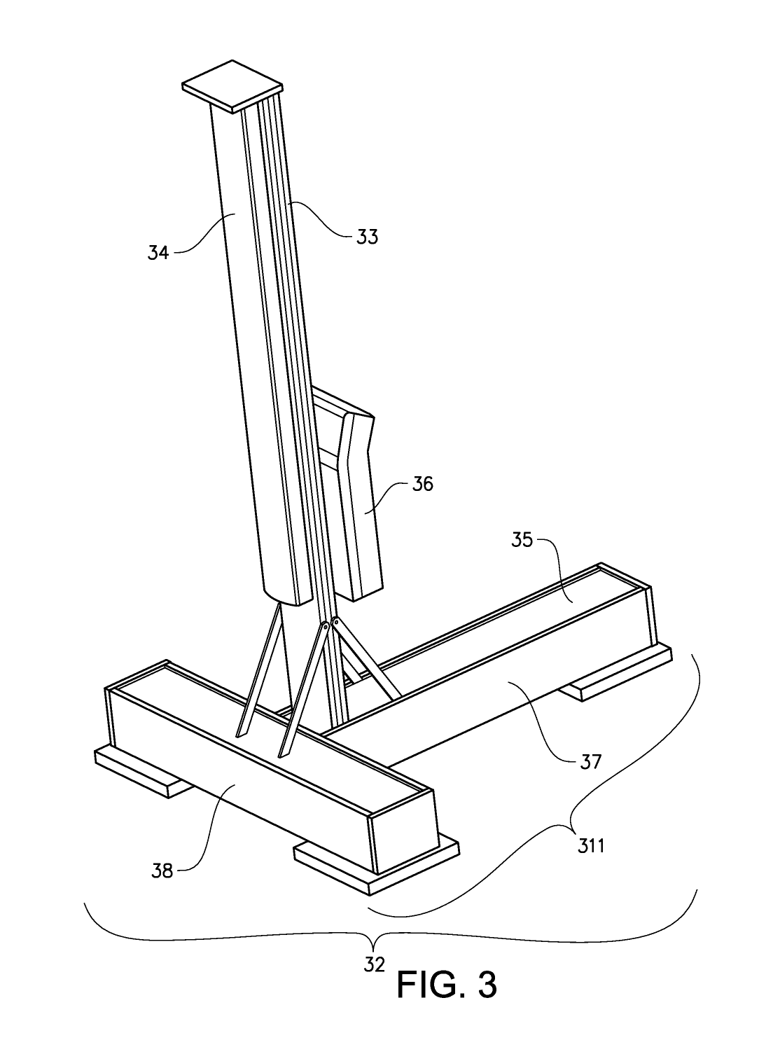

FIG. 3 illustrates a second embodiment of a cellular antenna site 32 in similarity with the cellular antenna site illustrated in FIG. 2. A first base member part 37 and a second base member part 38 are connected to each other to form a base member 311 in a similar way as described with reference to FIG. 1. An elongated support member 33 is attached to the base member 311. However, in this embodiment, poured concrete 35 is used as ballast material in order to anchor the base member 311 to the ground, either alone or in combination with stones or other suitable material. In this case, the cellular antenna site 32 may still be removed but it might require the removal of the entire base member 311 as one piece instead of disassembling the base member 311 into its components. Preferable, in this embodiment the step of filling the base member 311 with poured concrete is performed after the step of attaching the elongated support member 33 to the base member 311. In similarity to the embodiment illustrated in FIG. 2, an antenna 34 and a RRU 36 are attached to the elongated support member 33.

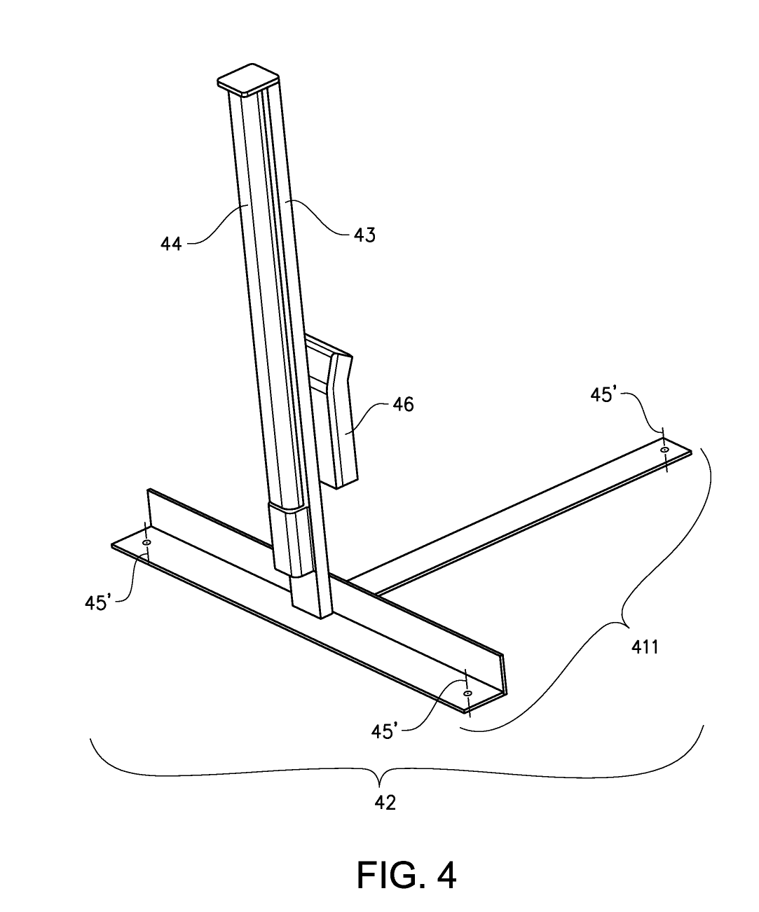

FIG. 4 describes a third embodiment of a cellular antenna site 42 erected from a portable construction set package comprising a package box 1 as illustrated in FIG. 1.

The package box 1 used for constructing the cellular antenna site illustrated in FIG. 4 is similar to the package box illustrated in FIG. 1, however, the joint 10 is omitted.

One sidewall 1j, 1j′ of the package box 1 (refer to FIG. 1) forms the elongated support member 43 for supporting the antenna 44 and a RRU 46, while the other three sidewalls 1d-1b, 1a-1c, 1i-1h are connected to each other in order to form the base member 411. According to this example embodiment, the base member 411 is penetratingly fastened to ground, e.g. by providing fastening means 45′ for connection to the ground at the base member 411. Preferably, the fastening means 45′ are provided at outside corners of the base member. The fastening means may e.g. be screws, bolts, ropes or other fastening or anchoring means. The fastening means 45′ can be used alone or in combination with ballast material retained in the base member 411 or placed on the base member 411. In order to anchor the cellular antenna side to the ground ballast material (not shown), e.g. stones, may be positioned upon the base member 411. Alternatively, means 45′ for penetratingly fastening the base member 411 to ground or to another structure, e.g. screws, may be used. In order to improve stability of the cellular antenna site 42, the means 45′ for penetratingly fastening the base member 411 are provided on outside corners of the base member, i.e. at corners of the base member remote from the elongated support member 43.

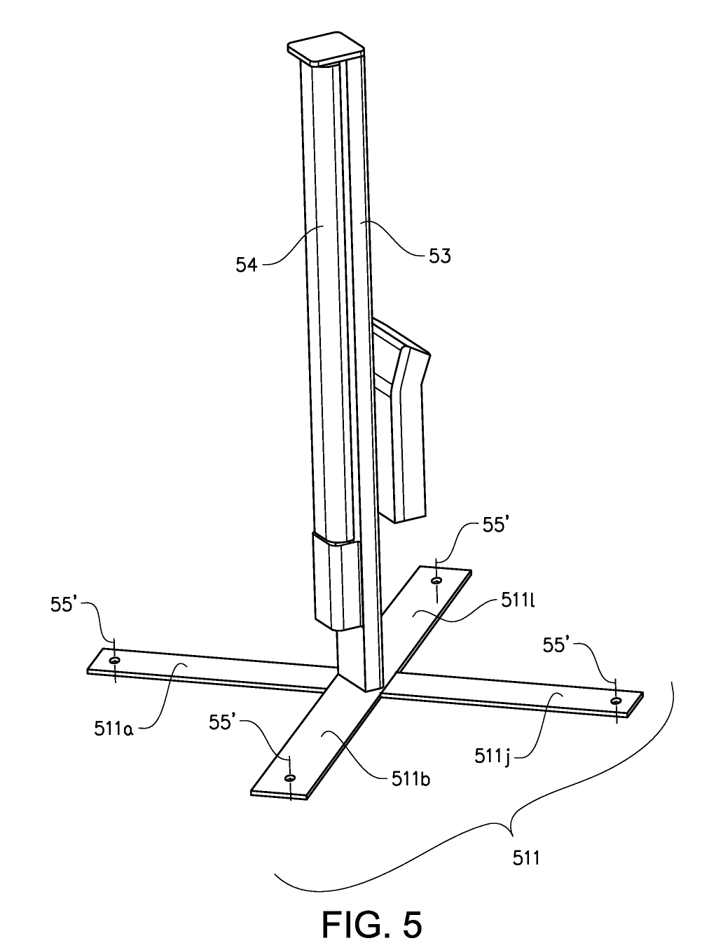

FIG. 5 shows a fourth embodiment of a cellular antenna site constructed from a portable construction set package as shown in FIG. 1. Prior to construction of the cellular antenna site 52, and as shown in FIG. 1, the lower parts 1a, 1b, 1j, 1h of the sidewalls or the package box are adjacent to the bottom plate 1g and pivotably connected to the bottom plate 1g, e.g. by hinges (not shown in FIG. 1). An antenna 54 is mounted to an elongated support member inside the package box 1 (not shown in FIG. 1). During construction of the cellular antenna site, the lower parts 1a, 1b, 1j, 1 h of the package box 1 (refer to FIG. 1) are pivoted outwards and form then parts 511a, 511b, 511j and 511h of the base member 511. The base member 511 comprises also the bottom plate 1g of the package box 1 which now forms a part 51g of the base member 511 of the cellular antenna site 52. The base member 511 is fastened to the ground by fastening means 55′, e.g. screws. Preferably the fastening means 55′ anchor the base member 511 penetratingly to the ground. The antenna 54 is fixedly attached to the elongated support member 53 which is positioned inside the package box prior to assembly (not shown in FIG. 1). Preferably a tilting mechanism (not shown) is provided between the antenna 54 and the elongated support member 53. The upper parts 1d, 1c, 1i, 1j′ of the sidewalls may be removed from the portable construction set package when the cellular antenna site 52 is constructed. Alternatively, some or all of the upper sidewall parts 1d, 1c, 1i, 1j′ and lower sidewall parts 1a, 1b, 1j, 1 h of the sidewalls are formed in one piece and form parts of the base member 511 in a similar way as described for the lower side wall parts 1a, 1b, 1j, 1h.

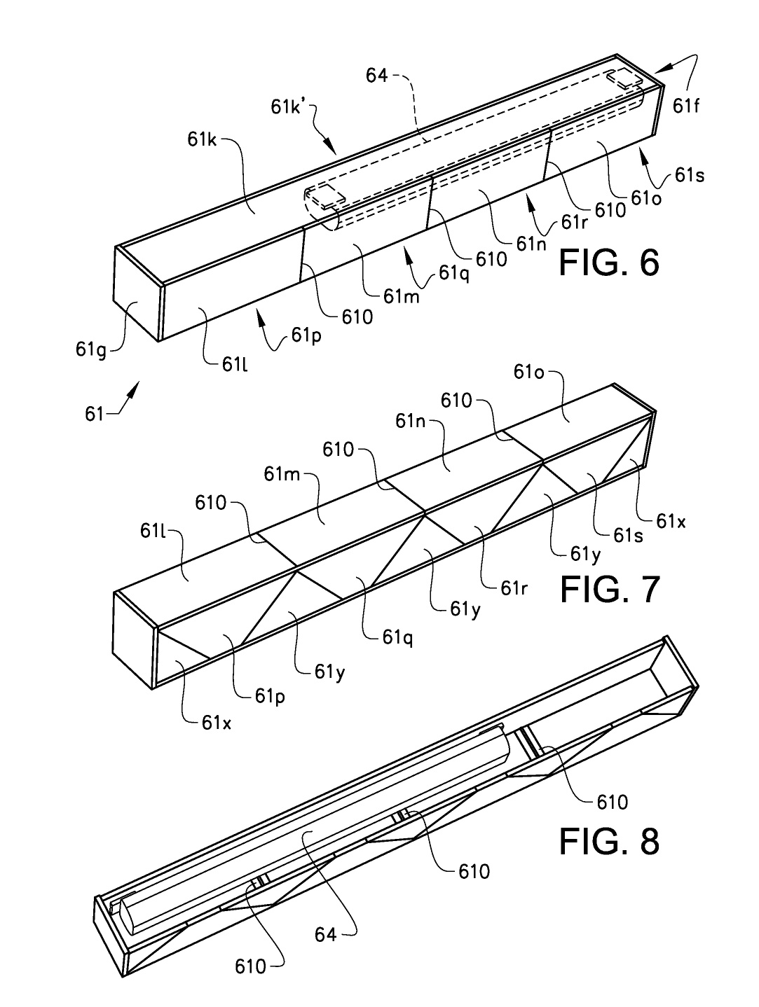

FIG. 6 shows another embodiment of a portable construction set package for constructing a cellular antenna site 62 according to a fifth embodiment. The portable construction set package comprises a package box 61 with four sidewalls, a top part 61f and a bottom part 61g. The package box comprises a plurality of package box parts 61l-61y, 61g, 61f, 610.

A first and a fourth sidewall of the package box are formed by a first and a fourth sidewall part 61k, 61k′ respectively. The first and the fourth sidewall parts 61 have substantially the same height as the package box. An antenna 64 is fixedly attached to the first sidewall part 61 k (see FIG. 8) and positioned inside the package box 61 prior to construction of the cellular antenna site. Alternatively, the antenna 64 may be fixedly attached to the fourth sidewall part 61k′ or to both the first sidewall part 61k and the fourth sidewall part 61k′.

A second sidewall of the package box is formed by a plurality of second sidewall parts 61l, 61m, 61n and 61o. Although in this example embodiment the number of second sidewall parts is four, the number of second sidewall parts is not limited to four, but may be another suitable number, e.g. two, three, five, six or seven. Each of these sidewall parts 61l, 61m, 61n and 61o has a substantially rectangular shape. Pivoting means 610, e.g. hinges, are provided between adjacent second sidewall parts 61l, 61m, 61n and 61o such that each of the second sidewall parts 61l, 61m, 61n and 61o is rotatably connected to an adjacent second sidewall part.

FIG. 7 shows the second and third sidewall of the package box 61 of the portable construction set package. The third sidewall of the package box comprises four third sidewall parts 61p, 61q, 61r and 61s. A number of third sidewall parts other than four, e.g. three, five, six or seven, is also possible. Preferably, the number of third sidewall parts corresponds to the number of second sidewall parts. Each of these third sidewall parts 61p, 61q, 61r and 61s has a trapezoid shape. Alternatively, each of the third sidewall parts may have a triangular shape. Furthermore, the third sidewall comprises three intermediate side parts 61y positioned between the third sidewall parts 61p, 61q, 61r and 61s. The third sidewall comprises also two end side parts 61x with a triangular shape. The third sidewall parts 61p, 61q, 61r and 61s form together with the two end side parts 61x and the three intermediate side parts 61y the third sidewall of the package box 61.

Each of the second sidewall parts 61l, 61m, 61n and 61o is fixedly attached to the corresponding third sidewall part 61p, 61q, 61r, 61s. The three intermediate side parts 61y may be attached to the neighboring third sidewall parts by removable joints. Alternatively, the three intermediate parts 61y may be fixedly attached to the neighboring third sidewall parts 61p, 61q, 61r, 61s. As an example, all or some of the third sidewall parts 61p, 61q, 61r, 61s and intermediate parts 61y may be formed in one piece. In this case, advantageously disconnection markings (not shown) are provided on the third sidewall in order to give instructions on how the third sidewall parts 61p, 61q, 61r, 61s and the intermediate parts 61y have to be disconnected for constructing the cellular antenna site.

The package box 61 comprises furthermore a top part 61f and a bottom part 61g. Top part 61f and bottom part 61g have an identical shape and may be rectangular.

FIG. 8 shows the portable construction set package with the fourth sidewall part 61k′ removed. The antenna 64 is mounted on the first sidewall part 61k such that the antenna 64 is protected inside the box prior to constructing a cellular antenna site. The dimensions of the package box 61 exceed the dimensions of the antenna 64 and provide space for further installation equipment, e.g. an installation kit or a RRU for the cellular antenna site.

During construction of the cellular antenna site the sidewall part(s) to which the antenna 64 is mounted is removed from the package box. As described above, the antenna 64 may be either attached to the first sidewall part 61k or to the fourth sidewall part 61k′ or to both. Accordingly, either the first sidewall part 61k or the fourth sidewall part 61k′ or both are removed from the package box 61. Thereafter, the three intermediate parts 61y are disconnected from the third sidewall of the package box 62, either by removing the removable joints (not shown) between the intermediate parts 61y and the corresponding third sidewall parts 61p, 61q, 61r, 61s or by disconnecting in an alternative way, e.g. by sawing or cut-off grinding along the disconnection markings (not shown).

Thereafter, each of the second sidewall parts 61l, 61m, 61n and 61o is pivoted about the pivoting means 610 such that a base member for retaining ballast material is formed by the second sidewall parts 61l, 61m, 61n and 61o and the attached third sidewall parts part 61p, 61q, 61r, 61s.

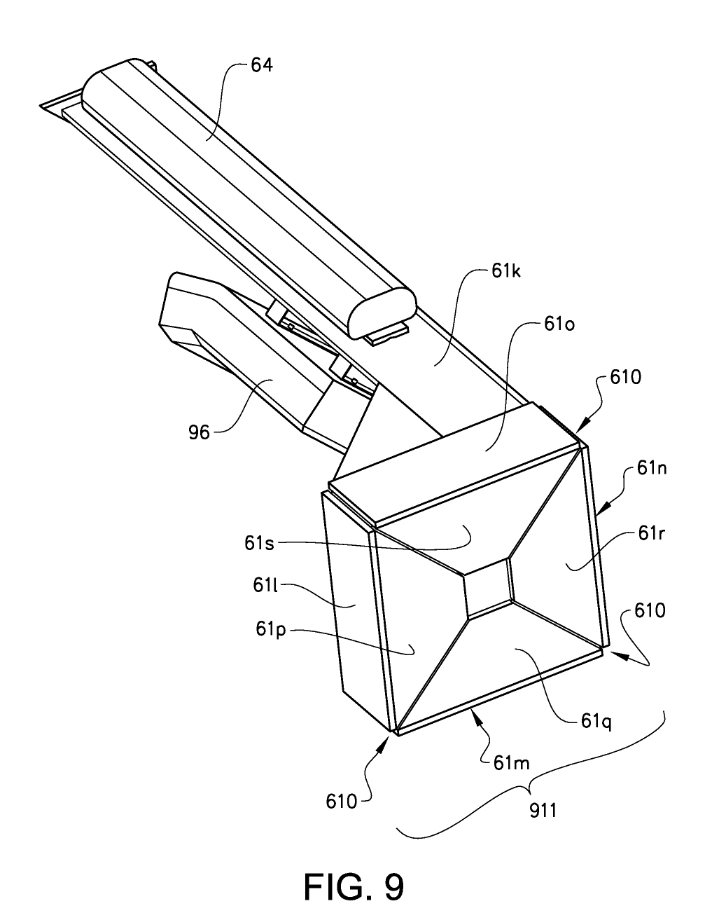

FIG. 9 shows a cellular antenna site 92 comprising a base member 911 formed by the second sidewall parts 61l, 61m, 61n and 61o and the attached third sidewall parts after rotating the second sidewall parts about the pivoting means 610. The base member 911 has a shape of an open container or box which is achieved by the shape of the second sidewall parts 61l, 61m, 61n and 61o and third sidewall parts 61p, 61q, 61r, 61s the base member. In order to achieve increased stability of the base member, optionally the second sidewall parts 61l, 61o having a free end may be connected to each other by a joint member 610′, e.g. a hinge or an elbow joint. In a next step, the sidewall part(s) 61k, 61k′ to which the antenna 64 is mounted form the elongated support member 93 and are positioned inside the base member 911 and secured to the base member 911.

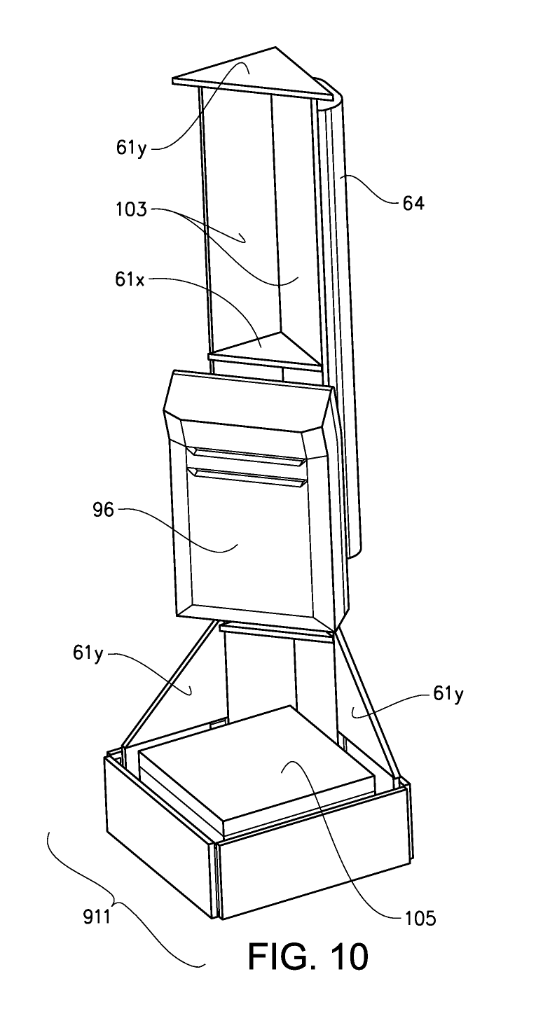

FIG. 10 shows a cellular antenna site 92 erected from the portable construction set package as shown in FIG. 6. The antenna 64 is fixedly attached to the first sidewall part 61k. The first sidewall part 61k has been connected to the fourth sidewall part 61k′ and forms now together with the first sidewall 61k an elongated support member 103 for the antenna 64. If, instead, the antenna is already pre-assembled with both the first sidewall part 61k and the fourth sidewall part 61k′ and the first sidewall part 61k is pre-assembled with the fourth sidewall part 61k′ then this pre-assembly may be positioned inside the base member 911 and secured to the base member 911.

At least one of the intermediate parts 61y of the third side wall is used to retain and support the first sidewall part 61k and the fourth sidewall part 61k′ in an upright position. The intermediate part 61y is positioned between the base member 911 and either the first sidewall part 61k or the fourth sidewall part 61k′. The intermediate part 61y may be wedged in between the base member and the first or the fourth sidewall part (61k, 61k′). Additionally or alternatively, the intermediate part 61y may be connected to the base member and the first sidewall part or fourth sidewall part 61k, 61k′, e.g. by screws or nails. Preferably, one of the intermediate parts 61y is used to support the first sidewall part 61k and another of the intermediate parts 61y is used to support the fourth sidewall part 61k′ in the manner described above.

As can be seen in FIG. 7, the third sidewall comprises three intermediate parts 61y of essentially same size and shape, however, number, shape and size may be varied. While two of the intermediate parts 61y may be used to support the elongated support member 103 with the antenna 64, another intermediate part may be mounted on top of the elongated support member and provide certain protection against environmental influences as well as contribute to an improved stability of the elongated support member 103. Furthermore, the end side parts 61x may be mounted to the elongated support member 103 for improved stability. A RRU 96 is mounted to the elongated support member 103 or to a part of the elongated support member 103, e.g. to the first sidewall part 61k or the fourth sidewall part 61k′.

During construction of the cellular antenna site, the base member 911 is filled with a suitable ballast material in order to anchor the base member to ground. As shown in FIG. 10, garden tiles may for instance be used as ballast material. Alternatively, stones or poured concrete, a combination of stones and concrete or any other material suitable as ballast material may be retained in the base member 911.

Modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of the disclosure and the appended claims. Although specific terms may be employed herein, they are used in a generic and descriptive sense only and not for purposes of limitation.

As used herein, the term “comprising” or “comprises” is open-ended, and includes one or more stated features, elements, steps, components or functions but does not preclude the presence or addition of one or more features, elements, steps, components, functions or groups thereof.

It will be understood that when an element is referred to as being “coupled”, “attached” or “connected” to another element, it can be directly coupled, attached or connected to the other element or intervening elements may also be present. In contrast, when an element is referred to as being “directly coupled”, “directly attached” or “directly connected” to another element, there are no intervening elements present.

1. A portable construction set package for constructing a cellular antenna site, wherein the portable construction set package comprises a package box and at least one antenna, wherein the package box is configured to protect the at least one antenna prior to construction of the cellular antenna site and comprises a plurality of package box parts, wherein at least one of the package box parts is configured to form a part of the cellular antenna site.

2. The portable construction set package according to claim 1, wherein each of the package box parts are configured to form a part of the cellular antenna site.

3. The portable construction set package according to claim 1, wherein the cellular antenna site comprises a base member and wherein at least one package box part is configured to form a part of the base member.

4. The portable construction set package according to claim 3, wherein the base member is configured to retain ballast material.

5. The portable construction set package according to claim 4, wherein the ballast material comprises poured concrete.

6. The portable construction set package according to claim 3, further comprising one or more penetrating fastening devices configured to penetratingly fasten the base member to ground.

7. The portable construction set package according to claim 3, wherein the at least one antenna is mountable to an elongated support member, the elongated support member being connectable to the base member.

8. The portable construction set package according to claim 7, further comprising a tilting mechanism configured to tilt the elongated support member with respect to the base member.

9. The portable construction set package according to claim 7, wherein at least one of the package box parts is a side wall of the package box and wherein the side wall is configured to form the elongated support member.

10. The portable construction set package according to claim 9, wherein the at least one antenna is fixedly attached to the side wall when the at least one antenna is positioned inside said package box.

11. The portable construction set package according to claim 3, wherein a first package box part is connected to a second package box part by one or more hinges, wherein the one or more hinges, the first package box part, and the second package box part are arranged such that by pivoting the first package box part and the second package box part with respect to each other around the one or more hinges a part of the base member is formed.

12. The portable construction set package according to claim 3, wherein the package box comprises a plurality of second sidewall parts and a plurality of hinges, each of said second sidewall parts being connected to an adjacent second sidewall part by one of the hinges, the plurality of second sidewall parts and the plurality of hinges being arranged such that by pivoting one or several second sidewall parts about the respective hinge with respect to the respective adjacent second sidewall part, a part of the base member is formed.

13. The portable construction set package according to claim 12, wherein the package box further comprises a plurality of third sidewall parts, wherein each of the second sidewall parts is fixedly attached to a corresponding third side wall part such that by pivoting one or several second sidewall parts together with the corresponding third sidewall part about the respective hinge with respect to the respective adjacent second side wall part, the base member is formed.

14. The portable construction set package according to claim 12, wherein the plurality of second side wall parts comprises at least four second sidewall parts, the package box comprises a corresponding number of third sidewall parts, and wherein each of the third sidewall parts has a triangular or trapezoid shape.

15. A cellular antenna site comprising at least one package box part from a package box within a portable construction set package, wherein the portable construction set package comprises the package box and at least one antenna, wherein the package box is configured to protect the at least one antenna prior to construction of the cellular antenna site and comprises a plurality of package box parts, wherein at least one of the package box parts is configured to form a part of the cellular antenna site.
